(19) United States
(12) Patent Application Publication
(10) Pub. No.: US 2022/0314633 A1
(43) Pub. Date: Oct. 6, 2022

(54) Inkjet Recording Device

(71) Applicant: Hitachi, Ltd., Chiyoda-ku, Tokyo (JP)

(72) Inventors: Koma SATO, Tokyo (JP); Eiji ISHII, Tokyo (JP)

(21) Appl. No.: 17/597,071

(22) PCT Filed: Feb. 13, 2020
(86) PCT No.: PCT/JP2020/005495

§ 371 Date: Dec. 23, 2021

(30) Foreign Application Priority Data
Jun. 25, 2019 (JP) 2019-117122

(51) Int. Cl. B41J 2/175

(52) U.S. Cl. CPC B41J 2/17596; B41J 2/17503; B41J 2002/022

(57) ABSTRACT

There is provided a novel inkjet recording device capable of preventing an ink droplet from being attached to and firmly fixed to a bent pipe part formed at a gutter. The device has a configuration where separately from air flowing through an inflow opening 36 of a gutter 29, secondary air is supplied to a bent region 34bent of a bent pipe part 34, the secondary air flowing in the same direction as air flowing out from an outflow 34out side of the bent pipe part 34. The ink droplet is prevented from being attached and fixed to the bent pipe part 34 formed at the gutter 29 because the secondary air can increase a flow rate of an air flow in an inner peripheral surface region 40 on an inner side of the bent pipe part 34.

### TECHNICAL FIELD

The present invention relates to an inkjet recording device. More particularly, the present invention relates to a continuous jet, charge control type inkjet recording device.

### BACKGROUND ART

This type of inkjet printing device is disclosed in, for example, Japanese Patent Application Laid-Open No. 2006-103092 (PTL 1). The inkjet recording device disclosed in PTL includes: an ink supply pump, a print head including a gutter, an ink recovery pump, and an ink container.

When pressurized by the ink supply pump, ink is jetted from a nozzle in the form of regular ink droplets by the operation of a piezoelectric device in a nozzle head. The jetted ink droplets are electrically charged by a charge electrode according to a print content. When passing through an electrostatic deflection field between deflection electrodes, the jetted ink droplets are so changed in flight direction as to be used for printing.

On the other hand, an ink droplet not electrically charged by the charge electrode is not deflected by the deflection electrodes but goes straight to be received by the gutter. The ink droplet is moved through an ink recovery path by a suction force of the ink recovery pump to be returned to the ink container for reuse. The gutter is normally formed of stainless steel having high strength and corrosion resistance.

### CITATION LIST

### Patent Literature

PTL 1: Japanese Patent Application Laid-Open No. 2006-103092

### SUMMARY OF INVENTION

### Technical Problem

As set forth in PTL 1, the gutter is formed of pipe bent into an “L” shape so as to receive the ink droplets jetted from the nozzle and to send the ink droplets to the ink recovery pump. The pipe configuration of the gutter is shown in FIG. 14.

Referring to FIG. 14, a gutter 60 is a cylindrical body made of stainless steel. An inflow opening 62 of an ink inflow pipe 61 is directed to the nozzle of the print head so that the inflow opening and the nozzle are in face-to-face relation. The ink inflow pipe 61 has a predetermined length and is connected to an ink outflow pipe 63 as substantially bent at a right angle in the midway. An arc-shaped bent pipe part 64 is formed at a connection region between the ink inflow pipe 61 and the ink outflow pipe 63. The ink outflow pipe 63 has a predetermined length, including an outflow opening 65 at an end thereof. The outflow opening 65 is connected to the ink recovery path.

A charge-free ink droplet 66 moves straight ahead in an arrowed direction, going inside the gutter 60 through the ink inflow pipe 61. Subsequently, the ink droplet 66 collides against an inner peripheral wall surface of the bent pipe part 64, wetting and spreading along the inner peripheral surface as illustrated by a collision region 67. Meanwhile, a part of the ink droplet is scattered by the collision, forming ink microdroplets 66s which are reattached to an inner peripheral wall surface around a bent region 64E of the bent pipe part 64.

Incidentally, air containing a volatile solvent and the ink droplet exists in the gutter 60. This air is sucked by the ink recovery pump disposed in the ink recovery path connected to the outflow opening 65. Hence, an air flow toward the outflow opening 65 is formed in the gutter 60. However, the air flow is sharply turned off by the bent pipe part 64 so that the flow rate of the air flow is relatively low in an inner peripheral surface region 68 on an inner side of the bent region 64E, where a whirlpool is generated as well. It is noted here that the inner peripheral surface region 68 on the inner side of the bent pipe part 64 is a region on an arc of the shorter radius as seen in a cross-section of the bent pipe part 64.

In some cases, therefore, the ink droplets may not be fully recovered because a phenomenon of reattachment of the scattered ink droplets occurs in the inner peripheral surface region 68 where the flow rate of the air flow is low and the whirlpool is generated. When the inkjet printing device is not in operation, therefore, the volatile solvent in the ink volatilizes so that the ink may be firmly fixed to the inner peripheral surface region 68 on the inner side of the bent pipe part 64. Further, if this problem occurs repeatedly, a circulation pathway in the gutter 60 is narrowed, resulting in an instable recovery of the ink droplet.

PTL 1 suggests a solution to cover an inner peripheral surface of the circulation pathway in the gutter 60 with a material having low surface tension. Unfortunately, this solution falls short in preventing the firm fixing of the ink droplets to the inner peripheral surface region 68 on the inner side of the bent pipe part 64 when the inkjet printing device is not in operation.

An object of the present invention is to provide a novel inkjet printing device adapted to prevent the ink droplet from being attached and fixed to the bent pipe part formed at the gutter.

### Solution to Problem

The present invention is characterized in that separately from air flowing through an inflow opening of the gutter, secondary air is supplied to a bent region of a bent pipe part, the secondary air flowing in the same direction as air flowing out from an outflow side of the bent pipe part to an ink outflow pipe.

### Advantageous Effects of Invention

According to the present invention, the ink droplet is prevented from being attached and fixed to the bent pipe part formed at the gutter because the secondary air can increase a flow rate of an air flow in an inner peripheral surface region on an inner side of the bent pipe part.

### BRIEF DESCRIPTION OF DRAWINGS

FIG. 1 is an external view of an inkjet recording device subject to the present invention.

FIG. 2 is a sectional view schematically showing a cross-section of the inkjet recording device shown in FIG. 1.

FIG. 3 is an explanatory diagram illustrating printing components related to printing and a printing operation of the inkjet recording device.

FIG. 4 is an explanatory diagram illustrating a behavior of ink droplets.

FIG. 5 is an external perspective view of a gutter according to a first embodiment of the present invention.

FIG. 6 is a sectional view showing a vertical cross-section of the gutter shown in FIG. 5 as taken in the axial direction thereof.

FIG. 7 is an external perspective view of a gutter according to a second embodiment of the present invention.

FIG. 8 is a sectional view showing a vertical cross-section of the gutter shown in FIG. 7 as taken in the axial direction thereof.

FIG. 9 is a top view of the gutter shown in FIG. 7, as seen from above.

FIG. 10 is a sectional view showing a vertical cross-section of a gutter according to a third embodiment of the present invention as taken in the axial direction thereof.

FIG. 11 is a sectional view of a bent pipe part shown in FIG. 10 as taken in a direction perpendicular to the axial direction thereof.

FIG. 12 is an explanatory diagram illustrating a state of an ink liquid film according to the third embodiment hereof.

FIG. 13 is an explanatory diagram illustrating a state of an ink liquid film of the prior art.

FIG. 14 is a sectional view showing a vertical cross-section of a gutter of the prior art as taken in the axial direction thereof.

### DESCRIPTION OF EMBODIMENTS

The embodiments of the present invention will hereinbelow be described in detail with reference to the accompanying drawings. It is to be understood that the present invention is not limited to the following embodiments but a variety of modifications and applications are construed as being included in the scope thereof in terms of technological concepts.

First, an inkjet recording device subject to the present invention is described with reference to the accompanying drawings.

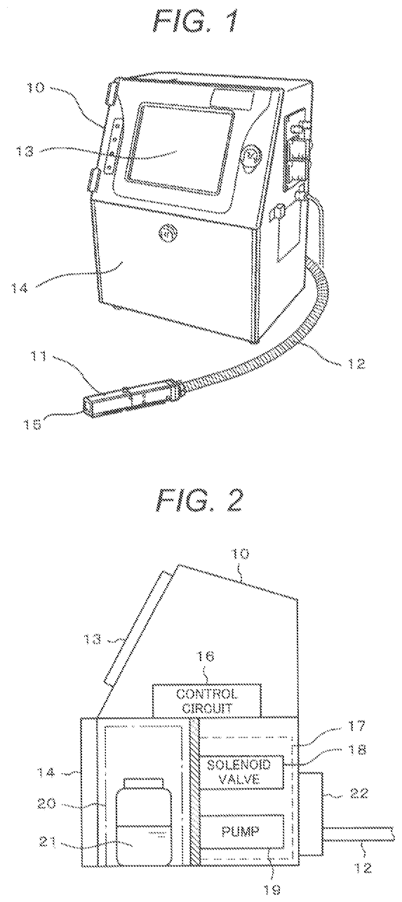

Referring to FIG. 1, an inkjet recording device has a configuration where a main body 10 and a print head 11 are interconnected by means of a conduit pipe 12. The main body 10 accommodates therein: a circulation system for circulating an ink and a solvent between the main body and the print head 11; and a control system for controlling the circulation system and printing operations. The main body 10 is provided with a touch-screen liquid crystal display 13 which allows a user to input print contents, print specifications, and the like, and to display control contents, an operational state, and the like. The touch-screen liquid crystal display 13 may be made separable from the main body 10. The main body 10 is provided with an openable main door 14 at a lower part thereof so that the user can open the main door 14 and perform maintenance for the circulation system in the main body 10 or replenish ink or solvent.

The print head 11 accommodates therein: a nozzle for jetting the ink to form the ink droplet; electrodes for electrically charging the ink droplet and deflecting the ink droplet; and a gutter for recovery of the ink droplet not used for printing. These components are covered with stainless steel covers. An opening 15 permitting the ink droplet to pass therethrough is formed at a distal end of the print head 11.

Next, an internal configuration of the main body 10 is described with reference to FIG. 2. FIG. 2 shows a vertical cross-section of the inkjet recording device. Electric components such as a control circuit 16 are disposed at an upper part of the main body 10. The liquid crystal display 13 is installed on a front surface of the upper part of the main body. In a front-side space 20 of a lower part of the main body 10, an ink container 21 storing the ink to be supplied to the nozzle, a solvent container (not shown) storing the solvent to be supplied to the nozzle, a densitometer (not shown) for detecting the density of the ink in the ink container 21, and the like are disposed.

In addition, circulation system control components including a solenoid valve 18, a pump unit 19 and the like are accommodated in a rear-side space 17 of the lower part of the main body 10. A back side of the main body 10 is connected to the print head 2 via the conduit pipe 12 in which pipes for inflow ink and outflow ink, high-voltage power supply lines for controlling individual electrodes and a control line are accommodated.

The main door 14 at the front-side space 20 of the main body 10 can be opened to permit the ink container 21 and the solvent container to be taken out from the main body 10. The main body is configured to facilitate the maintenance job such as replenishment or disposal of the ink and solvent.

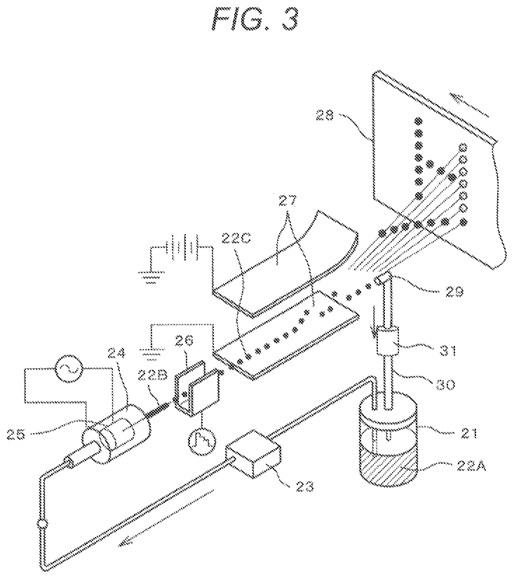

Next, the configuration and operations of the inkjet recording device are described with reference to FIG. 3. Referring to FIG. 3, an ink 22A stored in the ink container 21 is fed to a nozzle 24 as pressurized by an ink supply pump 23. The nozzle 24 is equipped with a piezoelectric device 25 which oscillates at a predetermined frequency when energized. Thus, the ink 22A is jetted from the nozzle 24 in the form of an ink pole 22B.

The jetted ink pole 22B is transformed into an ink droplet 22C. The ink droplet 22c is electrically charged by a charge electrode 26. The charged ink droplet 22C is deflected by a deflection electrode 27 to be deposited on a printing object 28. A charge-free ink droplet 22C is not used for printing and hence, is recovered by a gutter 29.

As described above, the nozzle 24 is equipped with the piezoelectric device 25 which transforms the ink pole 22B discharged from the nozzle 24 into liquid droplets by oscillating the ink 22A at the predetermined frequency. The number of the ink droplets 22C so generated depends upon the frequency of excitation voltage applied to the piezoelectric device 25. Thus, the number of the ink droplets 22C is equal to the frequency of the applied voltage.

The ink droplet 22C is charged by the charge electrode 26 which applies a voltage of a magnitude corresponding to printing information. The ink droplet 22C charged by the charge electrode 26 is deflected under a force proportional to the charge amount while flying through an electric field between the deflection electrodes 27. The ink droplet 22C flies toward the printing object 28 to be deposited thereon.

At the time, a deposition position of the ink droplet 22C with respect to a deflection direction varies in accordance with the charge amount. A production line enables the deposition of the liquid droplet even in a direction perpendicular to the deflection direction by moving the printing object 28 in the direction perpendicular to the deflection direction. The printing can be accomplished by forming characters of a plurality of deposited ink droplets 22C.

On the other hand, an ink droplet 22C not used for printing linearly flies between the deflection electrodes 12 and is captured by the gutter 29. Subsequently, the captured ink droplet is collected in the ink container 21 via an ink recovery path 30. An ink recovery pump 31 is provided on the ink recovery path 30 so that the ink droplet 22C captured by the gutter 29 is sucked in along with air so as to be collected in the ink container 21.

In the inkjet recording device having such a configuration, the air flow is sharply turned off by the bent pipe part of the gutter 29 as described above. In the inner peripheral surface region on the inner side of the bent pipe part, therefore, the flow rate of the air flow is relatively low and in addition, the whirlpool is generated. This leads to the phenomenon where the scattered ink droplets are attached again to the inner peripheral surface region. Accordingly, the ink droplet is not fully recovered. While the operation of the inkjet recording device is suspended, the volatile solvent in the ink volatilizes so that the ink may sometimes be firmly fixed to the inner peripheral surface region on the inner side of the bent pipe part.

### Example 1

In order to address the above-described problems, a first embodiment of the present invention suggests the following configuration.

According to the embodiment, a configuration is made such that separately from air flowing through an inflow opening of the gutter, secondary air is supplied to a bent region of the bent pipe part, the secondary air flowing in the same direction as air flowing out from an outflow side of the bent pipe part to an ink outflow pipe. According to this configuration, the flow rate of the air flow in the inner peripheral surface region on the inner side of the bent pipe part can be increased by the secondary air so that the ink droplet can be prevented from being attached and fixed to the bent pipe part formed at the gutter.

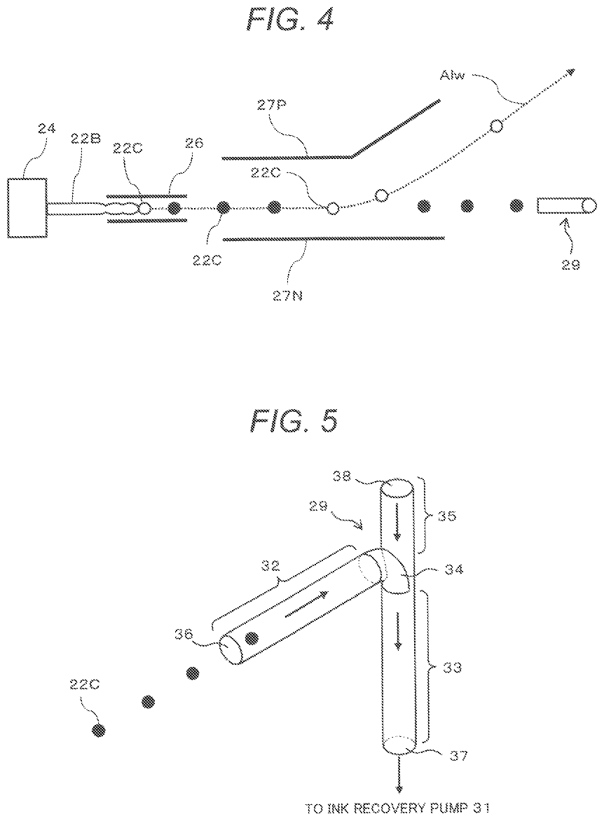

A configuration of the gutter of the inkjet recording device according to the embodiment is described as below. FIG. 4 illustrates a behavior of the ink droplet 22C. Referring to FIG. 4, the ink guided by the nozzle 24 is discharged from an outlet of the nozzle 24, thus forming the ink pole 22B. A piezoelectric device 25 which is excited at the predetermined frequency is implemented in the nozzle 24. Hence, surface tension waves are excited on the surface of the ink pole 22B by the oscillation of the piezoelectric device and become more developed as moved toward a downstream of the ink pole 22B.

A desired amount of charge can be imparted to the ink droplet 22C by controlling the potential of the charge electrode 26 in time with the separation of the ink droplet 22C from a tip of the ink pole 22B. In FIG. 4, a black dot denotes the charge-free ink droplet 22C not used for printing while a white dot denotes the charged ink droplet 22C used for printing.

The separated ink droplet 22C flies between the deflection electrodes 27. It is noted here that the deflection electrodes 27 include a positively charged deflection electrode 27P and a negatively charged deflection electrode 27N. In a case where the charged ink droplet 22C is negatively charged, a flight trajectory of the ink droplet 22C is deflected as indicated by an arrow Alw because the deflection electrode 27P is positively charged and the deflection electrode 27N is negatively charged.

Since the deflection amount depends upon the charge amount of the ink droplet 22C, the deposition position thereof on the printing object can be controlled by controlling the charge amount of the ink droplet. On the other hand, the charge-free ink droplet 22C not used for printing moves straight ahead to be captured by the gutter 29 and then, collected in the ink container.

Next, the description is made on a configuration of the gutter 29 according to the embodiment. FIG. 5 shows the gutter 29 as obliquely viewed from above. The gutter 29 is made of a stainless-steel cylindrical body. The gutter 29 includes: an ink inflow pipe 32; an ink outflow pipe 33 having an axis perpendicular to an axis of the ink inflow pipe 32; and a bent pipe part 34 interconnecting the ink inflow pipe 32 and the ink outflow pipe 33.

In addition to the above, the gutter further includes a secondary air inlet pipe 35 which is connected to the bent pipe part 34 and which is extended in the same direction as an axis of the ink outflow pipe 33 but is extended to the side opposite from the ink outflow pipe 33. It is noted here that the bent pipe part 34 is a generic term used to refer to a region where the air flowing through the ink inflow pipe 32 turns off toward the ink outflow pipe 33.

The air containing the ink droplet 22C flows into the ink inflow pipe through an inflow opening 36, moves through the ink inflow pipe 32, turns at right angle at the bent pipe part 34, and then moves to the ink outflow pipe 33. In the ink outflow pipe 33, the air containing the ink droplet 22C is sucked by the ink recovery pump 31 to be carried from an outflow opening 37 through the ink recovery path 30, and then is collected in the ink container 21. This is an operation of the general gutter 29.

According to the embodiment, on the other hand, the secondary air flows through an inlet opening 38 of the secondary air inlet pipe 35 and flows along the axis of the ink outflow pipe 33 at a predetermined flow rate. This secondary air serves to increase the flow rate of the air flow in the inner peripheral surface region on the inner side of the bent pipe part 34 and to prevent the generation of whirlpool. Thus, the ink droplet can be prevented from being attached and fixed to the bent pipe part 34 formed at the gutter 29.

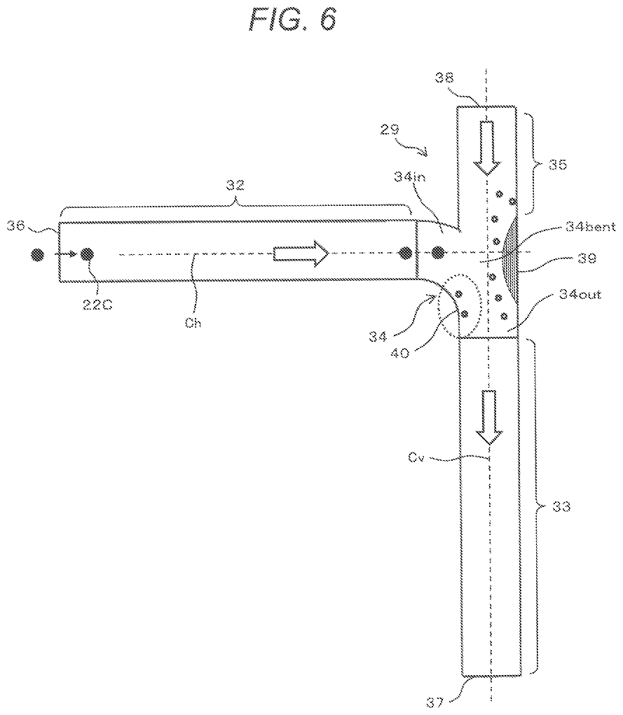

FIG. 6 illustrates the configuration of the gutter 29 in greater detail. Referring to FIG. 6, the gutter 29 includes: the ink inflow pipe 32, the ink outflow pipe 33 having an axis Cv perpendicular to an axis Ch of the ink inflow pipe 32; and the bent pipe part 34 interconnecting the ink inflow pipe 32 and the ink outflow pipe 33.

The bent pipe part 34 includes an inflow portion 34in connected to the ink inflow pipe 32, and an outflow portion 34out connected to the ink outflow pipe 33. A bent region 34bent is formed between the inflow portion 34in and the outflow portion 34out. An axis of the inflow portion 34in is identical with the axis Ch of the ink inflow pipe 32. An axis of the outflow portion 34out is identical with the axis Cv of the ink outflow pipe 33.

The secondary air inlet pipe 35 is connected to the bent region 34bent in a manner to extend in an opposite direction to that in which the ink outflow part 33 is extended. An axis of the secondary air inlet pipe 35 is identical with the axis Cv of the ink outflow pipe 33. Therefore, the ink outflow pipe 33 and the secondary air inlet pipe 35 can be regarded as a “straight pipe”.

When the air (blank arrow) containing the ink droplet 22C and flowing from the ink inflow pipe 32 runs into the bent pipe part 34, the air flows through the inflow portion 34in of the bent pipe part 34, making a 90-degree turn at the bent region 34bent and flowing out from the outflow portion 34out. In the bent region 34bent, the secondary air (blank arrow) flowing through the secondary air inlet pipe 35 joins up. An inflow direction of the secondary air flowing through the secondary air inlet pipe 35 is the same as that in which the axis of the outflow portion 34out continuous with the bent region 34bent is extended.

Therefore, the secondary air serves to force the air flowing in from the ink inflow pipe 32 to turn off. Therefore, the ink droplet 22C in the air can be prevented from being attached to an outer peripheral surface region 39 on an outer side of the bent region 34bent.

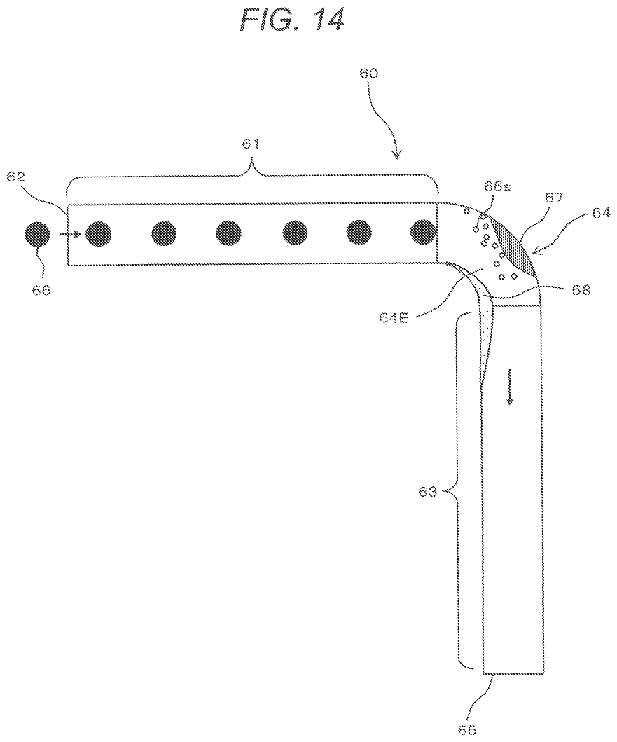

Just as described with reference to FIG. 14, in an inner peripheral surface region 40 on the inner side of the bent pipe part 34 as enclosed in a dotted ellipse, the air flow has a relatively low flow rate and the whirlpool is generated. According to the embodiment, on the other hand, the fast secondary air moving toward the ink outflow pipe 33 along the axis of the ink outflow pipe 33 is adapted to increase the flow rate of the air flow in the vicinity of the inner peripheral surface region 40 and also to prevent the generation of the whirlpool. The reattachment of ink microdroplets 22s can be prevented by an effect of the secondary air to reduce a low flow rate region (the inner peripheral surface region 40 enclosed in the dotted ellipse).

As just described, the ink microdroplets 22s scattered due to the collision of the ink droplet 22C against the outer peripheral surface region 39 on the outer side of the bent region 34bent are carried away by the flowing action of the secondary air. If the ink microdroplets should attach to the inner peripheral surface region 40, an effect to move the attached ink droplet 22C to the ink recovery pump 31 is increased. Thus, the embodiment can achieve an enhanced ink recovery performance.

The flow rate of the air flow in the inner peripheral surface region 40 on the inner side of the bent pipe part 34 can be increased by the secondary air. It results in a working effect to prevent the ink microdroplets generated in the bent pipe part 34 from flowing to the ink inflow pipe 32 and to enable the ink inflow pipe 32 to be reduced in the length thereof.

If the ink recovery pump 31 operates at a constant draw-in flow rate, the air is also recovered by the ink recovery pump 31 at a constant flow rate. Therefore, the amount of solvent volatilized in the air can be made substantially equal to that when the conventional gutter is used.

It is noted here that the secondary air inlet pipe 35 is open into the atmosphere via the inlet opening 38. However, the secondary air inlet pipe can also be communicated with an upper space of the ink solution 21. The volatilization of the volatile solvent can be further reduced by adopting a configuration where the air is circulated between the secondary air inlet pipe 35 and the ink container 21. A circular pipe, rectangular pipe and the like are usable as the pipes of the gutter 29.

Although FIG. 6 shows a pipe arrangement where a pipe constituting the ink inflow pipe 32 is bent at right angle with respect to a pipe constituting the ink outflow pipe 33. However, the pipe can be bent at any angle as needs dictate. The pipe constituting the ink outflow pipe 33 is connected to the bent pipe part 34 of the pipe constituting the ink inflow pipe 32. A cross-sectional shape and radius of the ink inflow pipe, a connection angle of the ink inflow pipe with respect to the bent pipe part 34, and the like can be changed as needed.

Instead of bending the pipe constituting the ink inflow pipe 32 followed by connecting thereto the pipe constituting the ink outflow pipe 33, a T-shaped pipe arrangement can also be made by using a “straight pipe” as the pipe constituting the ink inflow pipe 32, using a “straight pipe” as the pipe constituting the ink outflow pipe 33, and connecting these straight pipes together.

As just described, the embodiment is configured such that separately from the air flowing through the inflow opening 36 of the gutter 29, the secondary air is supplied to the bent region 34bent of the bent pipe part 34, the secondary air flowing in the same direction as the air flowing out from the outflow portion 34out of the bent pipe part 34. This configuration is adapted to prevent the ink droplets from being reattached and fixed to the bent pipe part 34 formed at the gutter 29 because the flow rate of the air flow in the inner peripheral surface region 40 on the inner side of the bent pipe part 34 can be increased by the secondary air.

Furthermore, the flow rate of the air flow in the inner peripheral surface region 40 on the inner side of the bent pipe part 34 can be increased by the secondary air so that the ink microdroplets generated in the bent pipe part 34 can be prevented from flowing to the ink inflow pipe 32. This results in a working effect to permit the ink inflow pipe 32 to be shortened.

### Example 2

Next, the description is made on a second embodiment of the present invention. The second embodiment differs in that the secondary air inlet pipe of this embodiment is a bent pipe whereas the secondary air inlet pipe 35 of the first embodiment is the straight pipe. This embodiment exemplifies a mode in a case where the configuration of the print header 11 makes it difficult to form the secondary air inlet path 35 of a long straight pipe. The same or equivalent components as those of the first embodiment will be referred to by like reference numerals, the description of which is dispensed with.

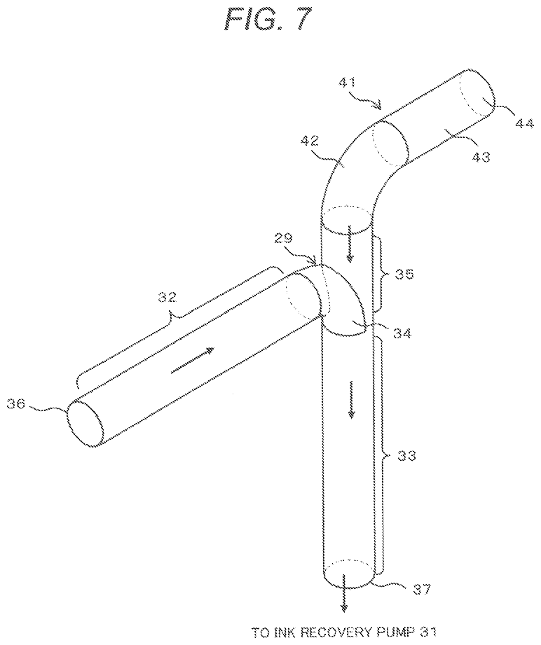

FIG. 7 shows the gutter 29 as obliquely viewed from above. Just as in the first embodiment, the gutter 29 is made of a stainless-steel cylindrical body. The gutter 29 of this embodiment has a bent pipe 41 connected to the secondary air inlet pipe 35 of the gutter 29 shown in FIG. 5.

It is noted here that the secondary air inlet pipe 35 is formed shorter than the first embodiment. In this embodiment, a unit including the secondary air inlet pipe 35 and the bent pipe 41 may sometimes be defined as “the secondary air inlet pipe”. In this manner, the secondary air inlet pipe 35 is formed shorter and has the bent pipe 41 connected thereto. Therefore, this embodiment is advantageous in a case where the print head 11 is limited in height.

The bent pipe 41 includes an arc-shaped bent pipe portion 42 connected to the secondary air inlet pipe 35 and a straight pipe portion 43. The straight pipe portion 43 is open into the atmosphere via an inlet opening 44. The axis of the ink inflow pipe 32 and an axis of the straight pipe portion 43 of the bent pipe 41 are in vertically spaced parallel relation as seen on the drawing surface. The straight pipe portion 43 of the bent pipe 41 is opposed to the ink inflow pipe 32 at an angle of 180° as seen from the ink inflow pipe 32.

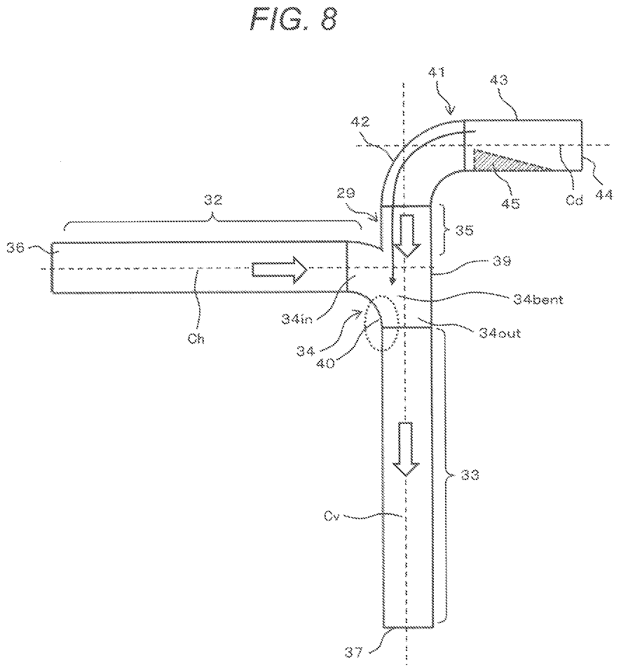

FIG. 8 illustrates a more detailed configuration of the gutter 29. Referring to FIG. 8, the secondary air inlet pipe 35 is connected to the bent region 34bent in a manner to extend in the opposite direction to that in which the ink outflow part 33 is extended. An axis of the secondary air inlet pipe 35 is identical with the axis Cv of the ink outflow pipe 33. Therefore, the ink outflow pipe 33 and the secondary air inlet pipe 35 can be regarded as the “straight pipe”.

The bent pipe 41 is connected to the secondary air inlet pipe 35. The bent pipe 41 includes the bent pipe portion 42 connected to the secondary air inlet pipe 35 and the straight pipe portion 43. The straight pipe portion 43 is open into the atmosphere via the inlet opening 44. An axis Cd of the straight pipe portion 43 of the bent pipe 41 is perpendicular to the axis Cv of the ink outflow pipe 33 and extends in the same direction as the axis Ch of the ink inflow pipe 32.

The air (blank arrow) containing the ink droplet 22C and flowing from the ink inflow pipe 32 runs into the bent pipe part 34, flowing through the inflow portion 34in of the bent pipe part 34, making the 90-degree turn at the bent region 34bent, and flowing out from the outflow portion 34out. In the bent region 34bent, the secondary air (blank arrow) flowing through the secondary air inlet pipe 35 joins up. The secondary air flows through the secondary air inlet pipe 35 in the same direction as the axis of the outflow portion 34out extends.

Therefore, the secondary air forces the incoming air through the ink inflow pipe 32 to turn off so that the ink droplet 22C in the air is prevented from being attached to the outer peripheral surface region 39 on the outer side of the bent region 34bent.

When the air through the straight pipe portion 43 of the bent pipe 41 runs into the bent pipe portion 42, more air is centrifugally drawn to the outer side of the bent pipe portion 42. Furthermore, the flow rate of the air also tends to increase. Therefore, the air (black arrow) flowing on an outer side of the bent pipe portion 42 can increase the flow rate of the air flow in the vicinity of the inner peripheral surface region 40 enclosed in the dotted ellipse on the inner side of the bent pipe part 34 and can also prevent the generation of whirlpool. By virtue of the resultant effect of reducing a low flow-rate region (the inner peripheral surface region 40 enclosed in the dotted ellipse), the reattachment of the ink microdroplets 22s can be suppressed.

It is also effective to form an air flow deflection part 45 at a transition area between the straight pipe portion 41 of the bent pipe 41 and the bent pipe portion 42. This air amount deflection part 45 has a function to direct the air flow through the straight pipe portion 43 to the outer side of the bent pipe portion 42, thus allowing more air to flow toward the outer side of the bent pipe portion 42. Incidentally, the air amount deflection part 45 can be formed by inwardly deforming a pipe wall of the straight pipe portion 43 from the outside.

The ink microdroplets 22s scattered on the outer peripheral surface region 39 on the outer side of the bent region 34bent by the collision of the ink droplet 22C are carried away by the flowing action of the secondary air. If the ink droplet should be attached to the inner peripheral surface region 40, the effect to move the attached ink droplet 22C to the ink recovery pump 31 is enhanced so that the ink recovery performance can be increased.

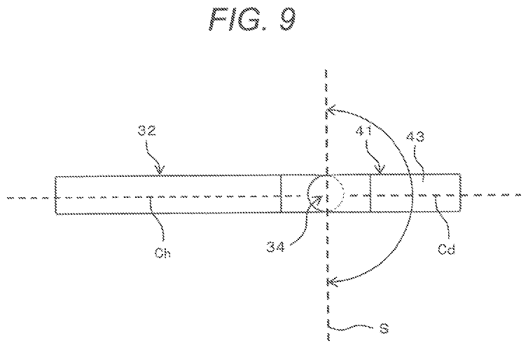

Next, the description is made on a positional relation between the ink inflow pipe 32 and the bent pipe 41 according to the embodiment. FIG. 9 is a top view of the gutter 29. The effect to reduce the low flow-rate region (the inner peripheral surface region 40 enclosed in the dotted ellipse) is maximized when the axis Ch of the ink inflow pipe 32 and the axis Cd of the straight pipe portion 43 of the bent pipe 41 are aligned with each other.

That is, the above reduction effect is maximized when the axis Ch of the ink inflow pipe 32 and the axis Cd of the straight pipe portion 43 of the bent pipe 41 forms an angle of 180°. This is because the fast air flow on the outer side of the bent pipe portion 42 of the bent pipe 41 shown in FIG. 7 is directly supplied to the inner peripheral surface region 40 of the bent pipe part 34.

In some cases, the above-described embodiment cannot be applied depending upon the configuration of the print head 11. However, if the bent pipe 41 is located about the axis Cv of the ink outflow pipe 33 and on the side of the straight pipe portion 43 with respect to a line segment S which is perpendicular to the axis Ch of the ink inflow pipe 32 and the axis Cd of the straight pipe portion 43 of the bent pipe 41, the reattachment of the ink microdroplets 22s can be prevented by virtue of the effect to reduce the low flow rate region.

As just described, this embodiment also has the configuration where separately from the air flowing through the inflow opening 36 of the gutter 29, the secondary air is supplied to the bent region 34bent of the bent pipe part 34, the secondary air flowing in the same direction as the air flowing out from the outflow portion 34out of the bent pipe part 34. According to this configuration, the flow rate of the air flow in the inner peripheral surface region 40 on the inner side of the bent pipe part 34 can be increased by the secondary air so that the ink droplet can be prevented from being reattached and fixed to the bent pipe part 34 formed at the gutter.

This embodiment is also configured such that the flow rate of the air flow in the inner peripheral surface region 40 on the inner side of the bent pipe part 34 can be increased by the secondary air. Thus, the embodiment can achieve the working effect to prevent the ink microdroplets generated in the bent pipe part 34 from flowing to the ink inflow pipe 32 so that the ink inflow pipe 32 can be reduced in length.

### Example 3

Next, the description is made on a third embodiment of the present invention. The third embodiment differs in that the ink droplets jetted from the ink inflow pipe to the bent pipe part are less scattered as colliding against the inner peripheral wall surface of the bent pipe part. The same or equivalent components as those of the first embodiment will be referred to by like reference numerals, the description of which is dispensed with.

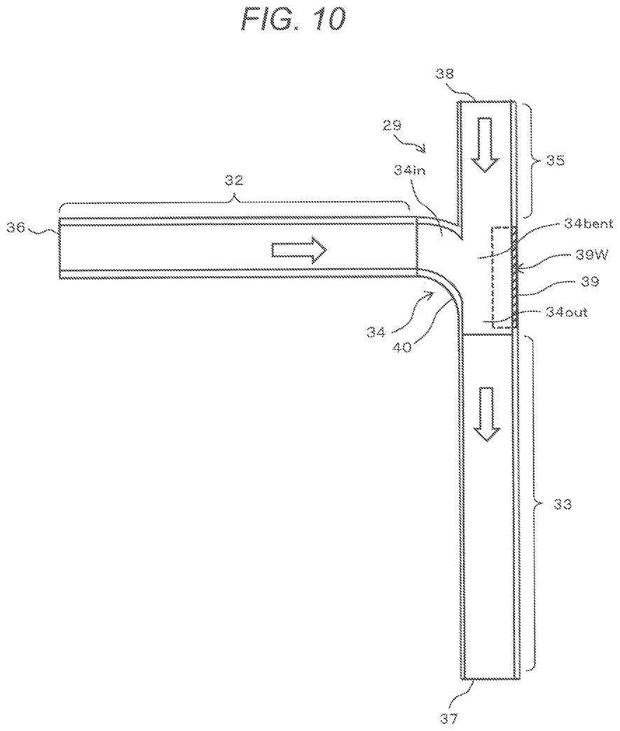

Referring to FIG. 10, when the ink droplet 22C collides against and attach to an area around the outer peripheral surface region 39 on the outer side of the bent region 34bent of the bent pipe part 34 opposed to the ink inflow pipe 32, the ink droplet 22C is scattered as ink microdroplets and reattach to the relevant area.

The most of the scattered ink droplets are the result of collision of the succeeding ink droplet 22C against an ink liquid film previously formed by the ink droplet colliding against the area around the outer peripheral surface region 39. The amount of scattered ink droplet depends upon the thickness of the ink liquid film formed on the area around the outer peripheral surface region 39. The greater the thickness of the liquid film, the greater the amount of the scattered ink droplets.

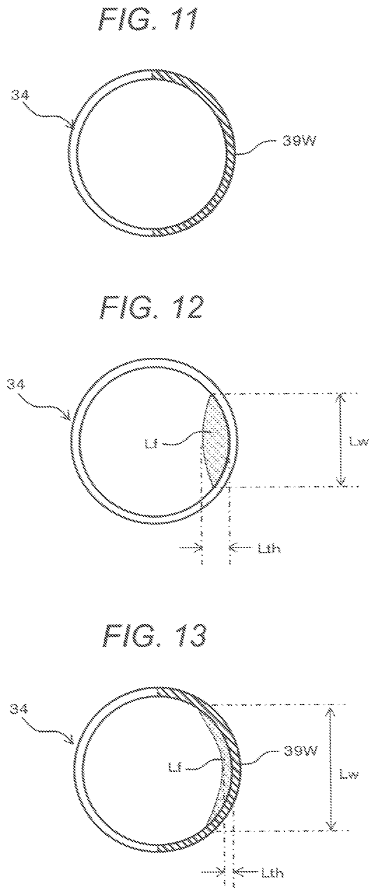

In this connection, the embodiment is configured to reduce the thickness of the liquid film by increasing the wettability of the area around the outer peripheral surface region 39 on the outer side of the bent region 34bent. The region to be increased in wettability only need to be equal to or larger than a region defined by extending the inflow portion 34in of the bent pipe part 34 to the outer peripheral surface region 39 (in short, a region against which the air flowing through the ink inflow pipe collides). According to the embodiment, as shown in FIG. 11, about a half of the bent region 34bent as seen in a radial cross-section is defined as a high wettability region 39W where the wettability is increased.

As a matter of course, the high wettability region 39W increased in the wettability must be formed on the opposite side of the bent pipe part 34 from the inflow portion 34in thereof. Namely, the high wettability region must be formed on a peripheral surface region of the bent pipe part on the opposite side from a connection portion between the ink inflow pipe and the bent pipe part.

The area, location, and the like of the high wettability region 39W increased in the wettability can be adjusted according to a reduced amount of the scattered ink droplets and processability of the pipe arrangement. As a method of increasing the wettability, there are a method of increasing surface roughness by pearskin finish such as shot blasting, a method of coating an area with a film of low wettability except for the high wettability region 39W increased in the wettability, and the like. Any of the well-known methods is usable.

Next, the description is made on the effect to reduce the amount of scattered ink droplets according to the embodiment. FIG. 12 shows the thickness of the ink liquid film in a case where the wettability is not controlled. In this case, the ink droplets are attached to the outer peripheral surface region 39 as colliding thereagainst. Because of the small wettability of the region, the attached ink droplets do not wet and spread along the configuration of the outer peripheral surface region 39. Within the range of a circumferential length Lw, the ink droplets form a liquid film Lf having a large thickness Lth. Therefore, the amount of scattered ink droplets increases, resulting in an increased amount of ink reattachment.

On the other hand, FIG. 13 shows the thickness of the ink liquid film in a case where the wettability is increased. In this case as well, the ink droplets collide against the outer peripheral surface region 39 and are attached thereto. Because of the great wettability, the attached ink droplets wet and spread along the configuration of the outer peripheral surface region 39. Within the range of the circumferential length Lw, the ink droplets form a liquid film Lf having a reduced thickness Lth. Therefore, the amount of scattered ink droplets can be reduced, resulting in a reduced amount of ink reattachment.

According to the embodiment, as just described, the ink droplet recovery performance can be improved by reducing the amount of ink droplets scattered from the attached ink droplets.

According to the present invention, as described above, the configuration is made such that separately from the air flowing through the inflow opening of the gutter, the secondary air is supplied to the bent region of the bent pipe part, the secondary air flowing in the same direction as the air flowing out from the outflow side of the bent pipe part to the ink outflow pipe. In this configuration, the flow rate of the air flow in the inner peripheral surface region on the inner side of the bent pipe part can be increased by the secondary air so that the ink droplet is prevented from being attached and fixed to the bent pipe part formed at the gutter.

It is noted that the present invention is not limited to the foregoing embodiments and can include a variety of modifications. The foregoing embodiments, for example, are the detailed illustrations to clarify the present invention. The present invention is not necessarily limited to those including all the components described above. Some component of one embodiment can be replaced by some component of another embodiment. Further, some component of one embodiment can be added to the configuration of another embodiment. A part of the configuration of each embodiment permits addition of some component of another embodiment, the omission thereof, or replacement thereof.

### REFERENCE SIGNS LIST

21: ink container
23: ink supply pump
24: nozzle
26: charge electrode
27: deflection electrode
29: gutter
30: ink recovery path
31: ink recovery pump
32: ink inflow pipe
33: ink outflow pipe
34: bent pipe part
34in: inflow portion
34out: outflow portion
34bent: bent region
35: secondary air inlet pipe

1. An inkjet recording device comprising:
an ink supply system which supplies an ink to a nozzle by pressurizing the ink in an ink container;
a print system which physically prints out by charging an ink droplet jetted from the nozzle, followed by deflecting the charged ink droplet; and
an ink recovery system which recovers the ink droplet not used for printing by means of a gutter and collects the ink droplet in the ink container,
wherein the gutter includes: an ink inflow pipe into which the ink droplet flows; a bent pipe part connected to the ink inflow pipe; and an ink outflow pipe connected to the bent pipe part, and
the gutter further includes a secondary air inlet pipe which, separately from air flowing into the ink inflow pipe through an inflow opening thereof, supplies secondary air to a bent region of the bent pipe part, the secondary air flowing in the same direction as air flowing out from an outflow side of the bent pipe part to the ink outflow pipe.

2. The inkjet recording device according to claim 1,
wherein the ink inflow pipe and the ink outflow pipe are interconnected by means of the bent pipe part in a manner that an axis of the ink inflow pipe is perpendicular to an axis of the ink outflow pipe, and
the secondary air inlet pipe has an axis identical with that of the ink outflow pipe and is located on the opposite side from the ink outflow pipe.

3. The inkjet recording device according to claim 2,
wherein the secondary air inlet pipe is either directly communicated with the atmosphere or communicated with an upper space of the ink container.

4. The inkjet recording device according to claim 3,
wherein the secondary air inlet pipe and the ink outflow pipe are formed in a straight pipe shape.

5. The inkjet recording device according to claim 3,
wherein the secondary air inlet pipe is formed in a bent pipe shape, and
the secondary air inlet pipe shaped like the bent pipe includes a bent pipe portion connected to the bent region of the bent pipe part, and a straight pipe portion connected to the bent pipe part.

6. The inkjet recording device according to claim 5,
wherein an axis of the straight pipe portion of the secondary air inlet pipe shaped like the bent pipe extends in the same direction as the axis of the ink inflow pipe.

7. The inkjet recording device according to claim 1,
wherein a peripheral surface region of the bent pipe part on the opposite side from a connection portion between the ink inflow pipe and the bent pipe part is defined as a high wettability region having high wettability.

8. The inkjet recording device according to claim 7,
wherein the high wettability region is formed by pearskin finish.

1. An inkjet recording device comprising:
an ink supply system which supplies an ink to a nozzle by pressurizing the ink in an ink container;
a print system which physically prints out by charging an ink droplet jetted from the nozzle, followed by deflecting the charged ink droplet; and
an ink recovery system which recovers the ink droplet not used for printing by means of a gutter and collects the ink droplet in the ink container,
wherein the gutter includes: an ink inflow pipe into which the ink droplet flows; a bent pipe part connected to the ink inflow pipe; and an ink outflow pipe connected to the bent pipe part, and
the gutter further includes a secondary air inlet pipe which, separately from air flowing into the ink inflow pipe through an inflow opening thereof, supplies secondary air to a bent region of the bent pipe part, the secondary air flowing in the same direction as air flowing out from an outflow side of the bent pipe part to the ink outflow pipe.

2. The inkjet recording device according to claim 1,
wherein the ink inflow pipe and the ink outflow pipe are interconnected by means of the bent pipe part in a manner that an axis of the ink inflow pipe is perpendicular to an axis of the ink outflow pipe, and
the secondary air inlet pipe has an axis identical with that of the ink outflow pipe and is located on the opposite side from the ink outflow pipe.

3. The inkjet recording device according to claim 2,
wherein the secondary air inlet pipe is either directly communicated with the atmosphere or communicated with an upper space of the ink container.

4. The inkjet recording device according to claim 3,
wherein the secondary air inlet pipe and the ink outflow pipe are formed in a straight pipe shape.

5. The inkjet recording device according to claim 3,
wherein the secondary air inlet pipe is formed in a bent pipe shape, and
the secondary air inlet pipe shaped like the bent pipe includes a bent pipe portion connected to the bent region of the bent pipe part, and a straight pipe portion connected to the bent pipe part.

6. The inkjet recording device according to claim 5,
wherein an axis of the straight pipe portion of the secondary air inlet pipe shaped like the bent pipe extends in the same direction as the axis of the ink inflow pipe.

7. The inkjet recording device according to any one of claims 1 to 5,
wherein a peripheral surface region of the bent pipe part on the opposite side from a connection portion between the ink inflow pipe and the bent pipe part is defined as a high wettability region having high wettability.

8. The inkjet recording device according to claim 7,
wherein the high wettability region is formed by pearskin finish.
